(19) United States
(12) Patent Application Publication
(10) Pub. No.: US 2005/0058068 A1
(43) Pub. Date: Mar. 17, 2005

(54) Refined quality of service mapping for a multimedia session

(76) Inventors: Racha Ben Ali, Montreal (CA); Yves Lemieux, Kirkland (CA); Samuel Pierre, Laval (CA)

Correspondence Address: Alex Nicolaescu;Ericsson Canada Inc., M/P/Department, 8400 Decarie Blvd., Town of Mount Royal, QC, H4P 2N2, CA

(21) Appl. No.: 10/893,335

(22) Filed: Jul. 19, 2004

Related U.S. Application Data
(60) Provisional application No. 60/489,929, filed on Jul. 25, 2003.

(51) Int. Cl. H04L 12/26

(52) U.S. Cl. 370/230; 370/401

(57) ABSTRACT

A method, a gateway and an authoritative node for refining quality of service (QoS) mapping for a plurality of packet flows transiting between two networks, wherein the packet flows pertain to a session, comprising capabilities for receiving a request for transiting the packet flows of the session between the two networks and if the request contains an appropriate authorization, associating at least a first one and a second one of the packet flows of the session transporting different types of content with at least a first and a second QoS levels in a mapping table and routing the packet flows between two networks in accordance with the associated QoS levels. Optionally, the step of receiving may further comprise communicating with an authoritative node to fetch a maximum authorized QoS level for each of the packet flows, wherein the QoS levels in the mapping table are set below the maximum authorized QoS level.

### PRIORITY STATEMENT UNDER 35 U.S.C S.119 (E) & 37 C.F.R. S.1.78

This non-provisional patent application claims priority based upon the prior U.S provisional patent application entitled “UMTS TO IP BACKBONE QoS MAPPING REFINEMENT FOR MULTIMEDIA TELEPHONY SERVICES”, application No. 60/489,929, filed July 25^{th}, 2003, in the names of Racha BEN ALI, Yves LEMIEUX and Samuel PIERRE.

### BACKGROUND OF THE INVENTION

1. Field of the Invention

The invention relates to Quality of Service (QoS) increase in IP networks for communications involving more than one type of content.

2. Description of the Related Art

For many years, Internet had been built as a “best effort” network. In other words, no Quality of Service (QoS) was implemented in the network. More recently, QoS has become a need with the convergence of technology toward the use of Internet and its Internet Protocol (IP). Essentially, QoS aims at improving the performance of the network by applying a set of parameters to the traffic on the network. These parameters are linked to characteristics of the network that can be managed. Examples of such parameters include the allocated bandwidth, the delay of a network link, the end-to-end delay of a transmission, the delay-jitter or delay variation and the data loss probability.

A few solutions were put forward in order to provide packet-switched IP networks with QoS. Examples of such solutions are Integrated Services (Int-Serv), Differentiated Services (Diff-Serv), Multiple Protocol Label Switching (MPLS).

Reference is now to FIG. 1, which shows a signal flow chart of an Int-Serv path according to prior art. The Int-Serv architecture envisions per-flow resources reservations with the use of pre-determined paths in an IP network 100. It achieves that through Resource Reservation Protocol (RSVP) signaling [RFC 2205]. In that scenario, an entry node 110, handling a service flow with certain QoS restrictions, uses an RSVP PATH message 150 to request a path of resources from all intermediate nodes or routers 120 and 130 towards its projected destination. As an exit node 140 receives PATH message 154, it initiates a RESERVE message 160 that reserves the admitted path of resources across the nodes 120 and 130 that the PATH message 150, 152 and 154 traversed from the entry node 110 to the exit node 140. Subsequent traffic forwarding therefore should experience requested QoS guarantees as a result of resource reservation over the deterministic path.

However, as it is expected for the Internet to expand tremendously, there is a concern regarding the scalability of the Int-Serv architecture. Millions and millions of micro-flows are expected to pass across internal Internet nodes. It becomes a huge burden for those nodes to maintain information and consistently satisfy requirements of such an enormous number of flows.

As a second solution, the Diff-Serv architecture provides simple scalable differentiated forwarding of IP traffic. Each Diff-Serv node supports a finite number of forwarding categories in the form of Per-Hop Behavior (PHB) groups [RFC 2475]. All traffic that belongs to one forwarding category is treated exactly in the same manner independently of their actual end-to-end requirements. Since internal nodes only handle a limited number of forwarding categories, the architecture is, indeed, scalable.

In order to provide QoS, Diff-Serv envisions Service Level Provisioning or Service Level Agreement (SLA) with a neighboring network. FIG. 2A is a flow chart of a reception of a packet flow in an entry node implementing Differentiated Services (Diff-Serv). As the packet flow is received 210 in the entry node of the Diff-Serv network from the neighboring network, a forwarding category becomes associated with the packet flow (step 212). The packet flow is also conditioned (step 214) to remain consistent with the neighboring network's established SLA. For instance, some packets from the packet flow may be dropped if the maximum packet rate specified in the SLA is exceeded.

As it can be appreciated, Diff-Serv drives complexity and decision making towards the edges of the network while allowing simple scalable forwarding at intermediate nodes between the entry node and the exit node. Currently three PHB groups are defined. The Expedited Forwarding (EF) [RFC 2598] PHB group provides high guarantees by allocating resources for the maximum arrival rate of the aggregate. The Assured Forwarding (AF) [RFC 2597] PHB group provides assurance for high probability forwarding without any strict delay requirements. The Default (DE) group represents the traditional Internet “best effort” traffic.

The steps taken by an internal node in order to forward the packet flow to its next destination is shown in FIG. 2B. It is to be noted that, in regular working state, a plurality of packet flows with different associated forwarding categories concurrently travel in the Diff-Serv network. In order to forward the packet flows, the internal node has three packet queues, each one having an associated PHB group (EF, AF or DE). When one packet flow is received by the internal node with a given associated forwarding category, it is stored in the corresponding queue in sequence of arrival. The internal node, concurrently to the reception of new packet flows, forwards the content of the queue by first determining if the highest quality queue (EF) is empty (step 220). If the EF queue contains at least one packet, the internal node forwards the oldest packet of the highest quality queue (EF) (step 222) and returns to step 220. If the EF queue is empty, the internal node determines if the intermediate quality queue (AF) is empty (step 224). If the AF queue contains at least one packet, the internal node forwards the oldest packet of the intermediate quality queue (AF) (step 226) and returns to step 220. If the AF queue is empty, the internal node determines if the lowest quality queue (DE) is empty (step 228). If the DE queue contains at least one packet, the internal node forwards the oldest packet of the lowest quality queue (DE) (step 230) and returns to step 220. If the DE queue is empty as well, the internal node returns to step 220 and so on.

While Diff-Serv does achieve scalable networks, there are no strict QoS guarantees. With Diff-Serv nodes, per flow reservation and therefore QoS guarantees are not possible. The architecture relies on the capability of the network to adequately manage its overall resources through conditioning actions in order to satisfy the agreed SLA. However, this is a very challenging task especially for large networks that rely on traditional routing where the path of traffic might be dynamic and unknown. Moreover, combined behavior of aggregate traffic from various neighboring networks cannot be anticipated even if all of them indeed lie within the bounds of their SLA. In order for a Diff-Serv network management to satisfy all SLA, sacrifices might become necessary in terms of network utilization to protect against worst case scenarios where all neighboring networks transmit at their maximum rates.

The third solution, MPLS [RFC 3031], aims at achieving fast and simple forwarding of IP traffic. In MPLS, routing information is signaled between neighboring nodes and a group of virtual paths known as Label Switched Paths (LSP) are established between the edges of the MPLS network. FIG. 3 shows an MPLS network 300 in which a packet flow 310 approaches the MPLS network 300 from a source 320 in order to reach a destination 330. The packet flow 310 is classified or labeled (step 332) by the MPLS network's entry node 110 onto an LSP that will adequately direct the packet flow 310 towards the exit node 140 and will also forward (step 333) the packet flow 310 toward the destination 330. Each MPLS node that participates in the LSP is known as a Label Switched Router (LSR) 325. Each LSR along the LSP has an incoming and outgoing labels binding that represent the routing information at each LSR 325 and indicate the forwarding direction as well as forwarding behavior to be applied to the packet flow 310. The incoming and outgoing labels for each LSR 325 therefore act as shorthand for routing and are pre-signaled between neighboring nodes through special protocols such as Label Distribution Protocol (LDP) [RFC 3036]. LSR 325 packet flow 310 forwarding (step 334) in that scenario becomes a simple label lookup and swapping (step 336) (change incoming to outgoing labels) operations rather than best prefix match as in traditional routing. When the packet flow 310 reaches the exit node 140 of the MPLS network 300, the packet flow is unlabelled (step 338) and forwarded (not shown) toward the destination 330.

Some extensions to existing routing protocols have been proposed to enable explicit routing in MPLS networks such as traffic engineering extensions to RSVP (RSVP-TE) and Constraint Routing LDP (CR-LDP). The main goal of explicit routing is to have only one destination for each entering packet bringing the logic of path establishment to the network's edges. Packets are classified at the edge into their explicit path and do not need to carry the explicit routing information as in traditional IP networks. Those extensions fill the objective of traffic engineering to avoid over-utilizing certain paths for traffic forwarding while other paths in the network remain under-utilized.

While MPLS simplifies forwarding of IP data, it does not provide QoS. In fact, MPLS nodes do not take any QoS parameters into account for the forwarding of packets, but rather interpret each packet's label to forward it accordingly.

Another more advantageous solution is also presented in a co-pending application from Yves Lemieux, Mohamed Ashour and Tallal Elshabrawy entitled “Quality of Service (QoS) mechanism in an Internet Protocol (IP) network” published under number US2004-0006613 herein included by reference. The basic concept of this last solution, also known as Novel Diff-Serv, is to dynamically adjust and update the QoS assigned to an end-to-end session on each link between each router on the way from one end to the other. The Novel Diff-Serv QoS mechanism thus provides efficiency and scalability since its flexible architecture enables a wider range of QoS needs to be answered. Another advantage of the flexible architecture presented in US2004-0006613 is the availability of fast and simple traffic forwarding mechanism throughout the IP network.

More recently, studies showed QoS problems when a session comprises different types of content. For instance, this situation can be found in a session transiting multimedia telephony services (e.g. video conference call) where both voice traffic and video traffic are combined therein. In such a case, it was shown that the requested QoS does not match the perceived QoS.

As it can be appreciated, no QoS mechanism provides a solution adapted to the fact that various types of content are present within a single multimedia session.

The present invention provides such a solution.

### SUMMARY OF THE INVENTION

A first aspect of the present invention is directed to a method for refining quality of service (QoS) mapping for a plurality of packet flows transiting between a first and a second communications networks, wherein a gateway is disposed therebetween and wherein the plurality of packet flows pertain to a session. The method comprises steps of receiving a request for transiting the plurality of packet flows of the session between the first and second communications networks, associating at least a first one and a second one of the plurality of packet flows of the session with at least a first and a second QoS levels in a mapping table and routing the plurality of packet flows between the first and the second communications networks in accordance with the associated QoS levels.

Optionally, the step of associating is only performed if the request contains an appropriate authorization. Yet another option is that the step of receiving may further comprise a step of communicating with an authoritative node to fetch a maximum authorized QoS level for each of the at least first and second packet flows transporting different types of content, wherein the at least first and second QoS levels in the mapping table are below the maximum authorized QoS level.

A second object of the present invention is directed to a gateway for mapping a plurality of packet flows between a first and a second communications networks, wherein the gateway is located therebetween and wherein the gateway comprises a mapping module. The mapping module is capable of receiving a request for transiting the plurality of packet flows of the session between the first and second communications networks, if the request contains an appropriate authorization, associating at least a first one and a second one of the plurality of packet flows of the session with at least a first and a second Quality of Service (QoS) levels in a mapping table and routing the plurality of packet flows between the first and the second communications networks in accordance with the associated QoS levels.

A third aspect of the present invention is directed to an authoritative node in a communications network comprising a control function wherein the control function is capable of receiving a plurality of parameters describing a session being established between a first node of the communications network and a second node located in a further communications network, identifying from at least one of the parameters that at least a first and a second different type of content are associated with the session and associating at least a first and a second maximum authorized Quality of Service (QoS) levels with the at least first and second different type of content associated with the session.

Optionally, the control function may be further capable of, upon reception of a session initiation message from the first node, issuing an authorization to transit the session from the communications network to the further communications through a gateway and, upon reception of a request from the gateway, issuing the at least first and second maximum authorized QoS levels associated with the session.

### BRIEF DESCRIPTION OF THE DRAWINGS

A more complete understanding of the present invention may be had by reference to the following Detailed Description when taken in conjunction with the accompanying drawings wherein:

FIG. 1 is a signal flow chart of a deployment of an Integrated Services (Int-Serv) path according to prior art;

FIG. 2A is a flow chart of a reception of a packet flow in an entry node implementing Differentiated Services (Diff-Serv) according to prior art;

FIG. 2B is a flow chart of a forwarding of packets in an internal node implementing Differentiated Services (Diff-Serv) according to prior art;

FIG. 3 is a signal flow chart of a Multiple Protocol Label Switching (MPLS) network handling a packet flow according to prior art;

FIG. 4 is an exemplary network topology in accordance with the present invention;

FIG. 5 is an exemplary flow chart of QoS mapping between two networks in accordance with the present invention;

FIG. 6 is an exemplary generic network topology in accordance with the present invention;

FIG. 7A is an exemplary flow chart of QoS mapping performed by a gateway between a first and a second communications networks in accordance with the present invention; and

FIG. 7B is an exemplary flow chart of QoS mapping performed by an Authoritative node in a first communications networks in accordance with the present invention.

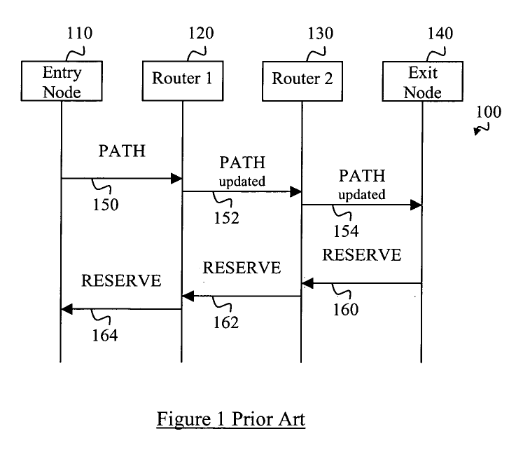

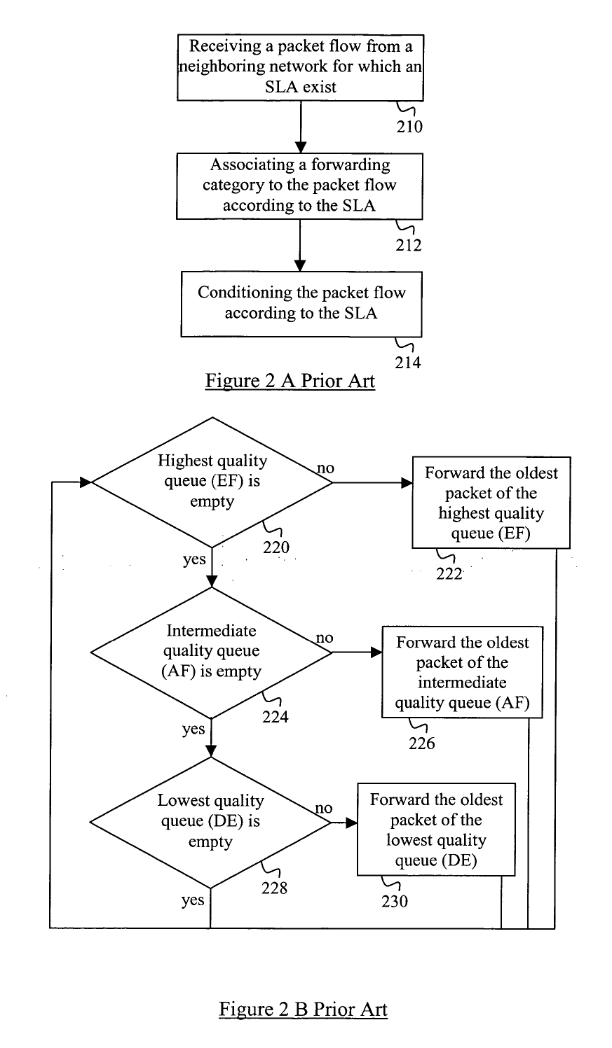

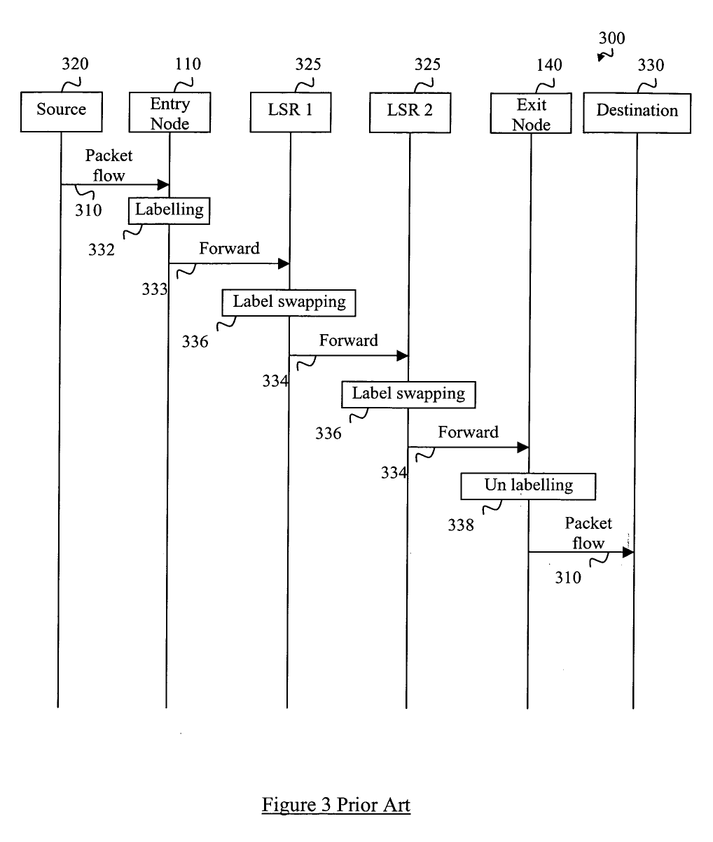

### DETAILED DESCRIPTION OF THE PREFERRED EMBODIMENTS

As mentioned earlier, all known solutions apply a single QoS treatment to all traffic pertaining to a single communication stream. For instance, in Diff-Serv, all packet flows related to a given session are assigned one QoS class.

The present invention provides solution for refining Quality of Service (QoS) when different types of content are present within a single multimedia session. The basic principle is to differentiate between the different types of content based, for instance, on an identifier linked to a packet or packet flow within the session and to provide a different QoS treatment in accordance to the identified type of content, thus maximizing the overall QoS of the session. This is achieved by mapping each type of content in the session to a specific QoS respecting, among other classic factors, the traffic characteristics of the type of content involved. In the following discussion, the invention is shown in a gateway node enabling communication between a Universal Mobile Telecommunications System (UMTS) network and an Internet Protocol (IP) network. The gateway node, in the UMTS context, is also known as a Gateway General Packet Radio Service Support Node (GGSN). It should be readily understood that the invention is applicable to any interconnected networks. For instance, two IP networks having different QoS policies can be connected with a gateway node in which mapping between the two networks QoS policies involves the present invention.

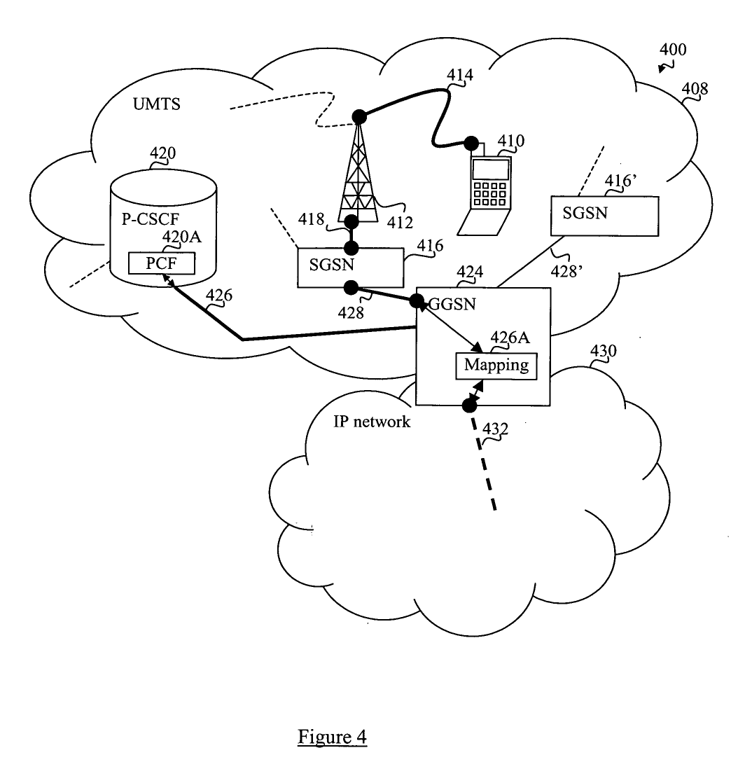

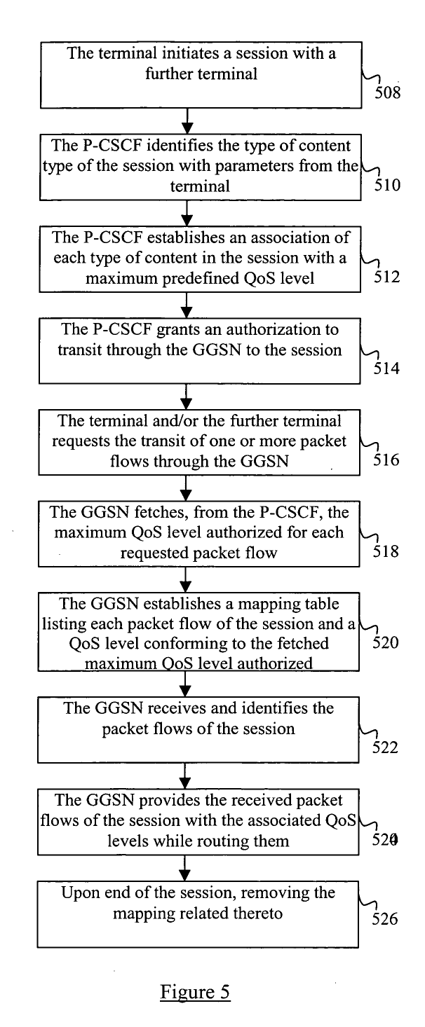

Reference is now made to the drawings where FIG. 4 shows an exemplary network topology 400 in accordance with the present invention. FIG. 4 shows a UMTS network 408 comprising one terminal 410 connected to a base station 412 via a wireless link 414. The base station 412 is in turn connected to a Serving General Packet Radio Service Support Node (SGSN) 416 via a link 418. The SGSN 416 is responsible, among other things, of managing the base station 412. The SGSN 416 is also linked to a Gateway General Packet Radio Service Support Node (GGSN) 424 via a link 428. The GGSN 424 is also connected to Proxy-Call State Control Function (P-CSCF) via a link 426. The P-CSCF 420, in usual implementation, also serves as a Session Initiation Protocol (SIP) proxy. The GGSN 424, which serves as a gateway toward an IP network 430, is then further connected to further nodes (not shown) of the IP network 430, as shown by a broken link 432 on FIG. 4. The UMTS network 408 and the IP network 430 are used as exemplary networks and contain, as such, many nodes, either shown or not, that serve optional roles in the present invention, as shown later on. It should be noted that the links 418, 426, 428 and 428′ are to be seen as logical links and not physical links since multiple nodes are usual placed thereon. For instance, the link 418 usually transits through a UMTS Terrestrial Radio Access Network (UTRAN) composed of one or more Radio Network Controller (RNC) (not shown) between the base station 412 and the SGSN 416. In the same manner, the link 428 is usually a Core Network (CN) composed of multiple interconnected routers (not shown).

It should be mentioned that others nodes used in the context of wireless communication in the UMTS network 408, such as a Home Subscriber Server (HSS) located in the circuit-switched domain of the UMTS network 408, are not shown on FIG. 4 since they do not affect the present invention, which is best fitted for packet-switched domain. Likewise, other nodes as a further SGSN 416′ and other terminals and base stations are likely to be found in the UMTS network 408. It should also be noted that the terminal 410 represents an exemplary terminal and should be seen as a generic terminal network equipment (e.g. UMTS smart-phone, Personal Digital Assistant (PDA), workstation, wireless server, etc.) through which a user of the UMTS network 408 communicates thereon. FIG. 4 further shows all nodes as separate entities connected via various links and it should be appreciated that this only represents one topology and that nodes can as well be collocated.

When the user of the terminal 410 is involved in initiation of a session (either self-initiating or terminating) with a further node (not shown), some messages are exchanged in order to establish the session. At the present moment, the standard that is best accepted by the industry seems to be Session Initiation Protocol (SIP), which specifies, among other things, a mechanism for establishing a session between two or more nodes. Other protocols could also be used without affecting the present invention (e.g. H.323). It should be noted that the session does not necessarily involve nodes where human users are present but can be established, for instance, between a content provider's server and the terminal 410.

Throughout the following discussion, the term QoS level refers to all parameters needed to provide a desired QoS in the session. Depending on the QoS mechanism used in the network, the QoS level does not refer to the same concept, but it should be apparent to those skilled in the art that the present invention is not linked to a specific QoS mechanism. In the example of a Diff-Serv QoS mechanism, QoS level refers to a QoS class assigned to the session or a portion (i.e. packet flows) thereof.

Reference is now made concurrently to FIG. 4 and FIG. 5, which shows an exemplary flow chart of QoS mapping between two networks in accordance with the present invention. FIG. 5 shows an example of steps necessary to implement the present invention. The steps of FIG. 5 will be introduced together with reference to the relevant node of FIG. 4.

In the following example, the user of the terminal 410 is the initiator of a session and SIP is used therefore. In order to initiate a session between the terminal 410, the UMTS network 408 and a further terminal (not shown) of a second network, a SIP invite message is sent from the terminal 410 having the further terminal as a participant of the session being established (step 508). The further terminal may be located in the IP network 430 or in another network (not shown), which is connected to the UMTS network 408 through the IP network 430. This is normally the case when the IP network 430 is an IP backbone network used to transit traffic between distant networks. The SIP invite message is conform to the standard and, as such, is sent toward the P-CSCF 420 via the wireless link 414 to the base station 412, the link 418 to the SGSN 416, the link 428 to the GGSN 424 and the link 426. The SIP invite message also contains Session Description Protocol (SDP) parameters that specify, among other things, what are the characteristics (a more complete view of the SDP parameters may be found in RFC2327 and RFC3266 published by the Internet Engineering Task Force (IETF)). For the present example, the SDP parameters can state that the session being established relates to a videoconference. Upon reception of the SIP invite message and the SDP parameters from step 508, the P-CSCF 420 identifies the type of content of the session being established (step 510). In the present example of a multimedia voice and video session, the different types of content are a conversational voice packet flow and a conversational video packet flow. The step 510 is likely to be performed by a Policy Control Function (PCF) 420A within the P-CSCF 420 using the SDP parameters therefore. Thereafter, the P-CSCF 420 establishes an association of each type of content in the session with a maximum predefined QoS level (step 512). Again, the PCF 420A is most probably the entity within the P-CSCF responsible of r performing the step 512. The P-CSCF 420 then grants an authorization to transit the session's packet flows between the UMTS network 408 and the IP network 430 toward the further terminal in a SIP OK message sent to the terminal 410 (step 514). The authorization is included in an authorization token in the SIP OK message, which also specifies, respecting the SIP standard, how the terminal 410 should proceed to reach the further terminal. In the present example, the authorization token is an authorization of the P-CSCF 420 to connect the session through the GGSN 424 in the IP network 430 toward the further terminal. The authorization further enables the terminal to use the appropriate QoS levels for the session's packet flows in accordance with the content thereof (as shown later on).

At this point in establishment of the session, the terminal 410 knows how to contact the further terminal, the authorization to connect through the GGSN 424 therefore has been obtained. The terminal 410 then continues with session establishment by sending a request toward the GGSN 424 to setup, among other things, the necessary mapping between the UMTS network 408 and the IP network 430 (steps 16). In the present example, the request is a Packet Data Protocol (PDP) context creation request and contains the authorization token received from the P-CSCF 420 in the SIP OK message. The request follows the path shown by the bold dotted lines on FIG. 4 up to the GGSN 424. Upon reception of the request (together with the authorization token), the GGSN 424 creates a PDP context for the session and contacts the P-CSCF 420 to fetch maximum authorized QoS levels related to the session being established (step 518). The P-CSCF 420 (usually through the PCF 420A), upon reception of the authorization token sent earlier to the terminal 410, sends already established maximum QoS levels to the GGSN 424. The GGSN 424 then establishes appropriate mapping for the session between the UMTS network 408 and the IP network 430 in a mapping table (step 520). The mapping table is used for maintaining the association of the different QoS levels for each of the different types of content the session in the GGSN 424. The mapping table contains a list of entries showing correspondence between all nodes of the session. Each listed entry may relate only to one packet flow of the session, thus enabling a differentiation in the QoS level of the different types of content of the session by having multiple entries for the session. Another possibility is to have a single entry listed for the session containing information on each packet flow thereof and the associated QoS level. In all cases, each packet flow should be individually identified in the mapping table together with an identifier linked to the session, (e.g. contained in the authorization token), the identifier being used in each packet of each packet flow (e.g. a flow-id, which could be a quintuplet composed of (source address, destination address, source port, destination port, protocol) of the session): Upon reception of the packet flow, the GGSN 424 identifies the packet flows pertaining to the session (step 522) through the identifier included in each packet. The GGSN 424 then fetches the QoS level associated to the identifier (i.e. each packet flow of the session) in the mapping table and provides the QoS level to the received packet flows of the session while routing them toward the further terminal (step 524).

The session can be ended either explicitly through appropriate SIP messages or implicitly through, for instance, detection of inactivity. In all cases, upon the end of the session, the mapping information related thereto is removed from the GGSN 424 (step 526).

In the preceding example, the QoS level was not explicitly linked to a given QoS mechanism. An exemplary QoS mechanism that seems to lead to satisfying results under simulation is a QoS mechanism composed of Diff-Serv where Weighted Fair Queue (WFQ) [Alan Demers, Srinivasan Keshav, and Scott Shenker. Analysis and simulation of a fair queuing algorithm. In Proc. ACM SIGCOMM '89, pages 1-12, Austin, Tex., September 1989] is used as the packet queuing mechanism (e.g. in the step 524). The ratio between the weight assigned to the video queue and the audio queue is shown by the following expression:

$$α = \frac{{W}_{audio}}{{W}_{video} + {W}_{audio}}$$

If W_{video}+W_{audio}=1, than experimentation shown that the optimal value of the ratio is obtained when α=0.26.

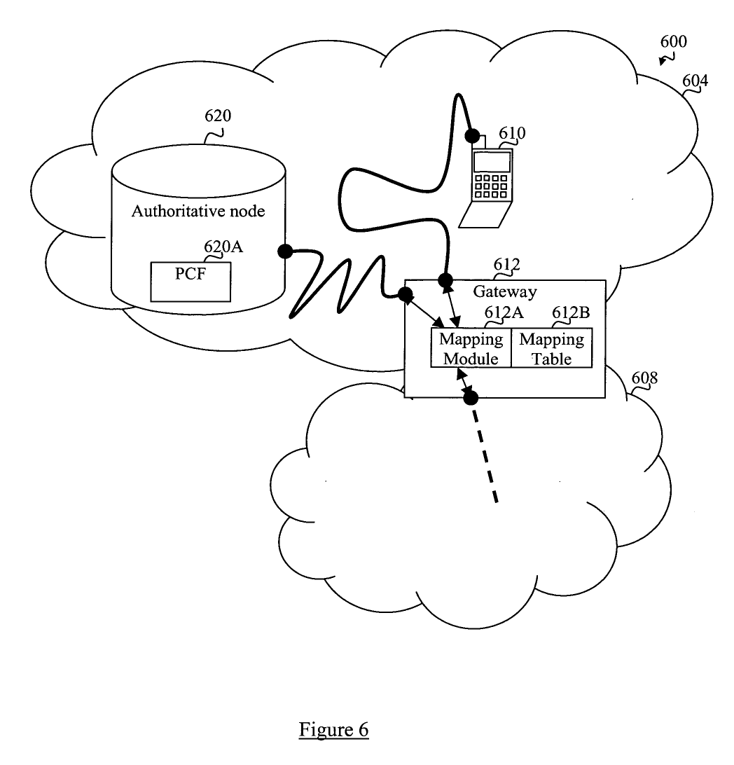

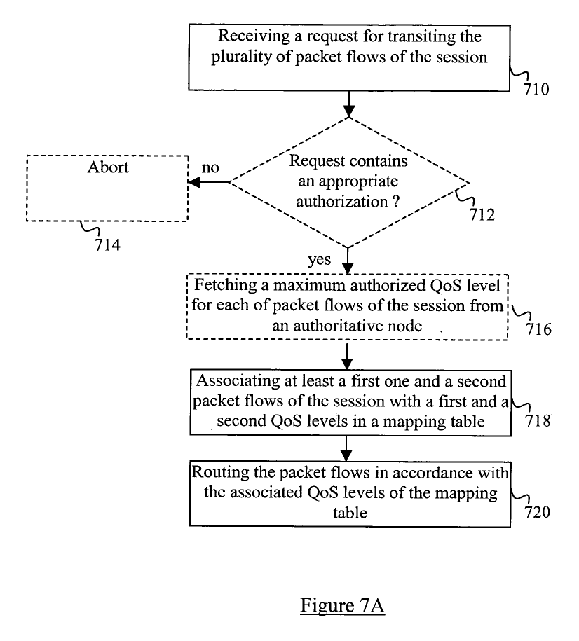

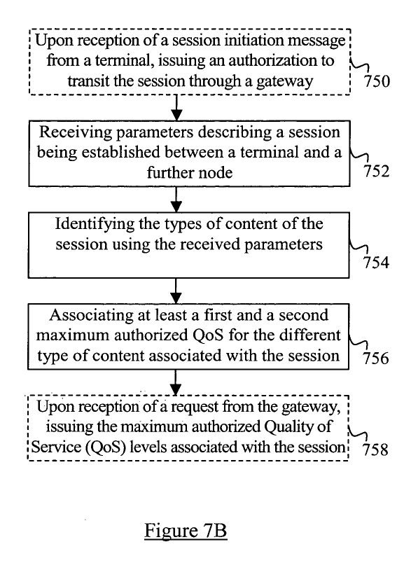

Reference is now made concurrently to FIG. 6 and FIG. 7A respectively showing an exemplary generic network topology 600 in accordance with the present invention and an exemplary flow chart of QoS mapping performed by a gateway between a first and a second communications networks in accordance with the present invention. FIG. 6 shows a terminal 610, the gateway 612 located between the first and the second communications networks 604 and 608. The gateway's behavior is managed from an authoritative node 620, which can be collocated or not with the gateway 612. The gateway 612 comprises a mapping module 612A and a mapping table 612B, which functioning is shown below. The gateway 612 implements a method for refining QoS mapping for a plurality of packet flows pertaining to a single session in which the terminal 610 is involved. The packet flows of the session are transiting between the first and the second communications networks 604 and 608 toward a further node (not shown) of the session.

Upon reception of a request from the terminal 610 for transiting the plurality of packet flows of the session between the first and second communications networks 604 and 608 (step 710), the gateway 612 may optionally first verify if the request contains an appropriate authorization (712) issued by the authoritative node 620. It is the responsibility of the terminal 610 to obtain the appropriate authorization from the authoritative node 620 before contacting the gateway 612. Obtaining the authorization as such is usually performed while establishing the session with the further node of the session. If the terminal 610 does not provide the appropriate authorization, the gateway 612 may abort the request (step 714, which can be done in many ways and falls outside the scope of the present invention). If the verification takes place and the request comprises the appropriate authorization or if no verification takes place, the gateway 612 associates at least a first one and a second one of the plurality of packet flows of the session with at least a first and a second QoS levels in the mapping table 612B (step 718). Optionally, the gateway 612 may communicate with the authoritative node 620 to fetch a maximum authorized QoS level for each of the at least first and second packet flows (step 716, shown in dashed lines on FIG. 7A to emphasize its optional nature). In such a case, the at least first and second QoS levels in the mapping table 612B are set below the maximum authorized QoS level. The gateway 612 then waits for the packet flows and routes them between the first and the second communications networks 604 and 608 in accordance with the associated QoS levels of the mapping table 612B (step 720). Many mechanisms can be implemented by the gateway 612 to satisfy the associated QoS levels. One appropriate mechanism, as shown earlier, is WFQ. The steps 710 to 720 of FIG. 7A are likely to be executed by the mapping module 612A of the gateway 612 with particular use of the mapping table 612B.

Reference is now concurrently made to FIG. 6 and FIG. 7B, which shows an exemplary flow chart of QoS mapping performed by the authoritative node 620 in the communications network 604. The authoritative node 620 comprises a control function 620A capable of receiving parameters describing a session being established between the terminal 710 of the communications network 604 and the further node located in a further communications network (not shown) (step 752). The further network can also be the second communications network 608 in some instances.

Using the parameters received from the terminal, the authoritative node 620, or its control function 620A, is capable of identifying that at least a first and a second different type of content are associated with the session (step 754). The authoritative node 620, or again its control function 620A, is then capable of associating at least a first and a second maximum authorized Quality of Service (QoS) levels with the at least first and second different type of content associated with the session (step 756).

Optionally, the control function 620A or the authoritative node 620 may be further capable of, upon reception of a session initiation message from the terminal 610, issuing an authorization to transit the session from the communications network 604 to the further communications through the gateway 612 (step 750). Likewise, upon reception of a request from the gateway 612, the control function 620A or the authoritative node 620 may issue the at least first and second maximum authorized QoS levels associated with the session (step 758).

It should be apparent to those skilled in the art that the GGSN 424 previously described with particular reference to FIGS. 4 and 5 is one implementation of the gateway 612. Likewise, the P-CSCF 420 described with particular reference to FIGS. 4 and 5 is one implementation of the authoritative node 620.

The innovative teachings of the present invention have been described with particular reference to exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale.

1. A method for refining quality of service (QoS) mapping for a plurality of packet flows transiting between a first and a second communications networks, wherein a gateway is disposed therebetween and wherein the plurality of packet flows pertain to a session, the method comprising steps of:
receiving a request for transiting the plurality of packet flows of the session between the first and second communications networks;
associating at least a first one and a second one of the plurality of packet flows of the session with at least a first and a second QoS levels in a mapping table; and
routing the plurality of packet flows between the first and the second communications networks in accordance with the associated QoS levels.

2. The method of claim 1, wherein the step of associating is performed by associating at least a first one and a second one of the plurality of packet flows transporting different types of content of the session with at least a first and a second QoS levels in a mapping table.

3. The method of claim 1, wherein the step of associating is performed only if the request contains an appropriate authorization.

4. The method of claim 1, wherein the step of receiving further comprises a step of communicating with an authoritative node to fetch a maximum authorized QoS level for each of the at least first and second packet flows, wherein the at least first and second QoS levels in the mapping table are below the maximum authorized QoS level.

5. The method of claim 4, wherein the step of communicating further comprises communicating with the authoritative node collocated with the gateway.

6. The method of claim 1, wherein the step of routing further comprises a step of queuing each of the plurality of packet flows in accordance with their associated QoS levels.

7. The method of claim 6, wherein the step of queuing further comprises using a weighted fair queue (WFQ) mechanism.

8. A gateway for mapping a plurality of packet flows between a first and a second communications networks, wherein the gateway is located therebetween and wherein the gateway comprises:
a mapping module capable of:
receiving a request for transiting the plurality of packet flows of the session between the first and second communications networks;
associating at least a first one and a second one of the plurality of packet flows of the session with at least a first and a second Quality of Service (QoS) levels in a mapping table; and
routing the plurality of packet flows between the first and the second communications networks in accordance with the associated QoS levels.

9. An authoritative node in a communications network comprising a control function, the control function being capable of:
receiving a plurality of parameters describing a session being established between a first node of the communications network and a second node located in a further communications network;
identifying from at least one of the parameters that at least a first and a second different type of content are associated with the session; and
associating at least a first and a second maximum authorized Quality of Service (QoS) levels with the at least first and second different type of content associated with the session.

10. The authoritative node of claim 9 wherein the control function is further capable of:
upon reception of a session initiation message from the first node, issuing an authorization to transit the session from the communications network to the further communications through a gateway; and
upon reception of a request from the gateway, issuing the at least first and second maximum authorized QoS levels associated with the session.
